(19) United States
(12) Patent Application Publication
(10) Pub. No.: US 2019/0115733 A1
(43) Pub. Date: Apr. 18, 2019

(54) WIRING-HARNESS CONTROL FOR ROBOTIC INSTALLATION

(71) Applicant: Delphi Technologies, Inc., Troy, MI (US)

(72) Inventors: David R. Peterson, Aurora, OH (US); Joseph Sudik, JR., Niles, OH (US); Frank Walter Szuba, JR., El Paso, TX (US); Andrew Kneppers, San Jose, CA (US)

(21) Appl. No.: 15/784,780

(22) Filed: Oct. 16, 2017

(51) Int. Cl. H02G 1/06; B60R 16/02

(52) U.S. Cl. CPC H02G 1/06; B60R 16/0215

(57) ABSTRACT

A wiring-harness retaining device is configured to retain a predetermined-point of a wiring-harness in a predetermined-position. The device includes a substrate and a retention-feature. The substrate defines a surface. The retention-feature is disposed on the surface. The retention-device is configured to retain the wiring-harness to the surface until a removal-force applied to the wiring-harness exceeds a predetermined-threshold. The predetermined-point of the wiring-harness is presented to an assembler in the predetermined-position.

### TECHNICAL FIELD OF INVENTION

This disclosure generally relates to a wiring-harness, and more particularly relates to a wiring-harness having an wiring-harness retaining device.

### BACKGROUND OF INVENTION

The typical vehicle wiring-harness may be several meters in length and may contain multiple branches that interconnect electrical components to electrical power and/or computer controllers. The multiple wiring-harness branches typically terminate with electrical-connectors that may be temporarily attached to the wiring-harness with adhesive tape, or other temporary attachment methods, to protect the electrical-connectors during unpacking and handling. Removal of the adhesive tape in a vehicle assembly plant is required before the wiring-harness is installed into the vehicle, and may typically be performed by a human during the installation process.

As assembly vehicle processes are increasingly automated, there may be a desire to use a robotic installer for installing a wire harness within the vehicle. However, in order to do this, a robotic assembler must be able to consistently locate the multiple connectors on the harness and remove the adhesive tape. These are both fairly complex operations for a robot.

Therefore, a vehicle wiring-harness that is configured to be more easily handled by a robotic installer remains desired.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### SUMMARY OF THE INVENTION

In accordance with one embodiment, a wiring-harness retaining device is provided. The wiring-harness retaining device is configured to retain a predetermined-point of a wiring-harness in a predetermined-position. The device includes a substrate and a retention-feature. The substrate defines a surface. The retention-feature is disposed on the surface. The retention-device is configured to retain the wiring-harness to the surface until a removal-force applied to the wiring-harness exceeds a predetermined-threshold. The predetermined-point of the wiring-harness is presented to an assembler that is a robot in the predetermined-position.

The retention-feature may be an exposed adhesive layer that is formed of a fugitive-glue material. The retention-feature may also be a flexible L-shaped-member projecting beyond the surface that is integrally formed with the substrate, and the substrate and the L-shaped-member are formed of the same material.

The predetermined-threshold is in a range from about 40 Newtons to about 60 Newtons. The retention-feature locates the predetermined-point on the substrate with a true-position of less than 5.0 millimeters relative to the predetermined-position.

In another embodiment, a method of installing a wiring-harness in a motor vehicle is provided. The method includes the steps of providing a substrate, disposing a wiring-harness, and removing the wiring-harness. The step of providing the substrate includes providing the substrate defining a surface having a retention-feature disposed on the surface. The retention-feature is configured to retain the wiring-harness to the surface until a removal-force applied to the wiring-harness exceeds a predetermined-threshold. The step of disposing the wiring-harness includes disposing the wiring-harness within the retention-feature such that a predetermined-point of the wiring-harness is in a predetermined-position. The step of removing the wiring harness includes removing the wiring-harness from the retention-feature by applying the removal-force using a robot.

The retention-feature may be an exposed adhesive layer that is formed of a fugitive-glue material. The retention-feature may also be a flexible L-shaped-member projecting beyond the surface that is integrally formed with the substrate, and the substrate and the L-shaped-member are formed of the same material.

The predetermined-threshold is in a range from about 40 Newtons to about 60 Newtons. The retention-feature locates the predetermined-point on the substrate with a true-position of less than 5.0 millimeters relative to the predetermined-position.

In yet another embodiment, a retaining-device configured to retain a wiring-harness, is provided. The retaining-device includes a substrate and a retention-feature. The retention-feature is disposed on the substrate. The substrate is configured to locate and retain the wiring-harness until a robot applies a removal-force to the wiring-harness.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is an illustration of a wiring-harness retaining device in accordance with one embodiment;

FIG. 2 is an illustration of a close-up view of a wiring-harness retaining device in accordance with one embodiment;

FIG. 3 is a flow chart of a method of installing a wiring-harness that includes the wiring-harness retaining device of FIG. 1 in accordance with another embodiment;

FIG. 4 is an illustration of a wiring-harness retaining device in accordance with yet another embodiment; and

FIG. 5 is an illustration of a close-up view of a wiring-harness retaining device in accordance with yet another embodiment;

The reference numbers of similar elements in the embodiments shown in the various figures share the last two digits.

### DETAILED DESCRIPTION

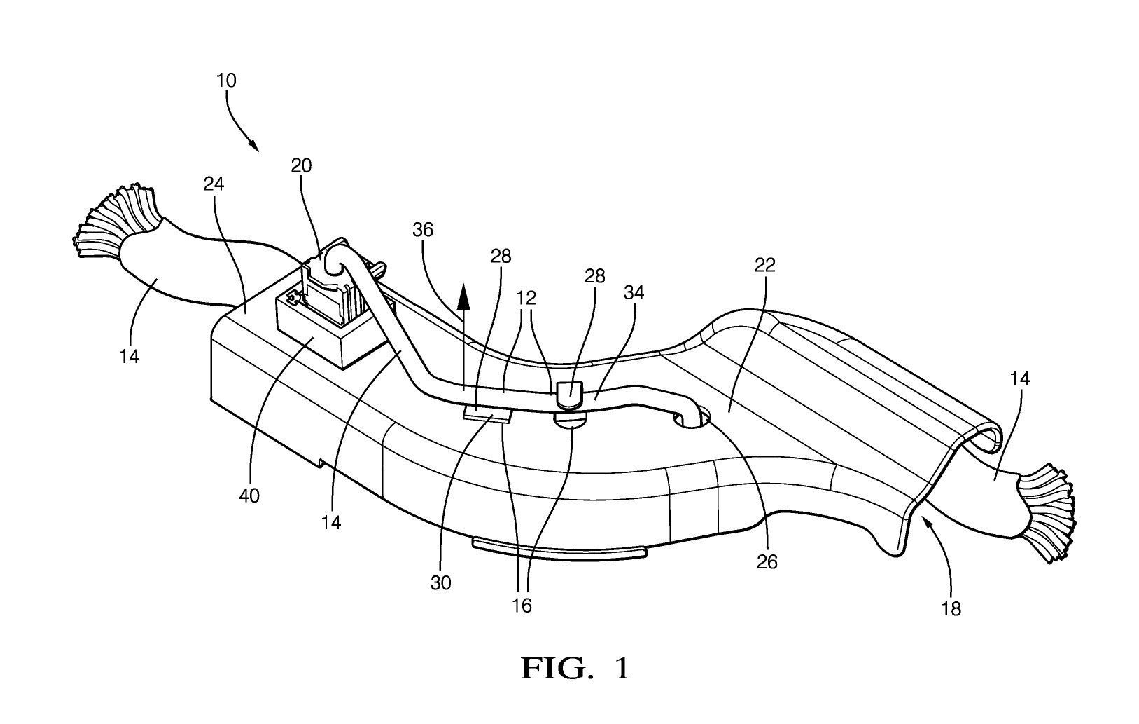

FIG. 1 illustrates a non-limiting example of a wiring-harness retaining device 10, hereafter referred to as the device 10, configured to retain a predetermined-point 12 of a wiring-harness 14 in a predetermined-position 16. As will be described in more detail below, the device 10 is an improvement over prior art retaining-devices because it reduces the use of adhesive tapes that typically require manual labor for removal. The device 10 may be fabricated of a polymeric-material and may house the wiring-harness 14 in an interior chamber 18. The device 10 may be fixed to an automobile (not shown) during an assembly operation of the vehicle using any of the fasteners (not shown) known to those in the art.

The wiring-harness 14 may include a main-branch (not specifically shown) and wire-bundles (not specifically shown) that may attach to the main-branch within the device 10 (i.e. within the interior chamber 18). Both the main-branch and the wire-bundles may include electrical-connectors 20 at a terminal-end.

The device 10 includes a substrate 22 defining a surface 24, wherein the surface 24 may further define apertures 26 that connect the surface 24 to the interior chamber 18. The wiring-harness 14 may pass through the apertures 26 for attachment to the surface 24, as will be described in more detail below.

The device 10 also includes a retention-feature 28 disposed on the surface 24 configured to retain the wiring-harness 14 to the surface 24. Preferably, the retention-feature 28 may locate the predetermined-point 12 of the wiring-harness 14 on the substrate 22 with a true-position of less than 5.0 millimeters (5 mm) relative to the predetermined-position 16. As used herein, the true-position is an allowable tolerance window surrounding the predetermined-position 16 in which the location of the predetermined-point 12 may exist.

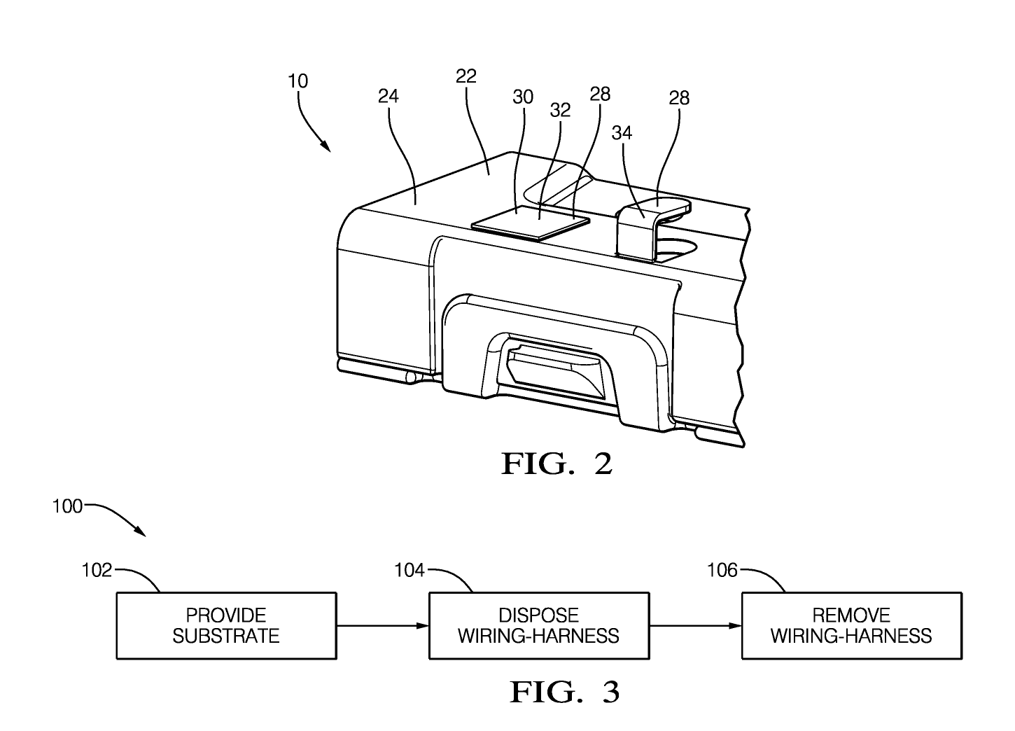

FIG. 2 illustrates a section of the device 10 with the wiring-harness 14 removed to more clearly show the retention-features 28. The retention-feature 28 may include an exposed adhesive layer 30 that may be formed of a fugitive-glue material 32. The fugitive-glue material 32 may be any fugitive-glue material 32 that is suitable for temporarily joining the substrate 22 material to the wiring-harness 14 material. The fugitive-glue material 32 may be configured to receive and retain the wiring-harness 14 with a cable-diameter (not shown) ranging from about 2 mm to about 30 mm.

The retention-feature 28 may also include a flexible L-shaped-member 34 projecting beyond the surface 24, as illustrated in FIG. 2. Preferably, the L-shaped-member 34 may be integrally formed with the substrate 22 and may be formed of the same material as that of the substrate 22. The L-shaped-member 34 may be configured to receive and retain the wiring-harness 14 with the cable-diameter ranging from about 2 mm to about 30 mm.

The retention-feature 28 is configured to retain the wiring-harness 14 to the surface 24 until a removal-force 36 applied to the wiring-harness 14 exceeds a predetermined-threshold 38 that may preferably be in a range from about 40 Newtons to about 60 Newtons. The removal-force 36 is preferably applied to the wiring-harness 14 in a direction normal to the surface 24, but may also be applied at angles from zero degrees to 180 degrees, depending on a type and an orientation of the retention-feature 28.

The predetermined-point 12 of the wiring-harness 14 may be presented to an assembler in the predetermined-position 16. This is advantageous when the assembler may be a robot (not shown), as the robot may locate and avoid entanglement in the wiring-harness 14 during an installation procedure. The removal-force 36 may result from the robot that grasps and moves the electrical-connector 20 retained in a staging-device 40 that may be located on the surface 24, as illustrated in FIG. 1. The robot may remove the electrical-connector 20 from the staging-device 40 thereby moving the attached wiring-harness 14 away from the surface 24 to create the removal-force 36. The robot may mate the electrical-connector 20 with a corresponding-electrical-connector (not shown) as part of the installation procedure. The wiring-harness 14 may disengage from the retention-feature 28 during the installation procedure, depending on a distance and a direction of the movement of the wiring-harness 14 by the robot.

FIG. 3 is a non-limiting example of another embodiment of a method 100 of installing a wiring-harness 14 in a motor vehicle (not shown).

Step 102, PROVIDE SUBSTRATE, may include providing a substrate 22 defining a surface 24 having a retention-feature 28 disposed on the surface 24. The surface 24 is configured to retain the wiring-harness 14 to the surface 24 until a removal-force 36 applied to the wiring-harness 14 exceeds a predetermined-threshold 38.

FIG. 1 illustrates a non-limiting example of a wiring-harness retaining device 10, hereafter referred to as the device 10, configured to retain a predetermined-point 12 of the wiring-harness 14 in a predetermined-position 16. As will be described in more detail below, the device 10 is an improvement over prior art retaining-devices because it reduces the use of adhesive tapes that typically require manual labor for removal. The device 10 may be fabricated of a polymeric-material and may house the wiring-harness 14 in an interior chamber 18. The device 10 may be fixed to the motor vehicle during an assembly operation of the vehicle using any of the fasteners (not shown) known to those in the art.

The wiring-harness 14 may include a main-branch (not specifically shown) and wire-bundles (not specifically shown) that may attach to the main-branch within the device 10 (i.e. within the interior chamber 18). Both the main-branch and the wire-bundles may include electrical-connectors 20 at a terminal-end.

The device 10 includes the substrate 22 defining the surface 24, wherein the surface 24 may further define apertures 26 that connect the surface 24 to the interior chamber 18. The wiring-harness 14 may pass through the apertures 26 for attachment to the surface 24, as will be described in more detail below.

FIG. 2 illustrates a section of the device 10 with the wiring-harness 14 removed to more clearly show the retention-features 28. The retention-feature 28 may include an exposed adhesive layer 30 that may be formed of a fugitive-glue material 32. The fugitive-glue material 32 may be any fugitive-glue material 32 that is suitable for temporarily joining the substrate 22 material to the wiring-harness 14 material. The fugitive-glue material 32 may be configured to receive and retain the wiring-harness 14 with a cable-diameter (not shown) ranging from about 2 mm to about 30 mm.

The retention-feature 28 may also include a flexible L-shaped-member 34 projecting beyond the surface 24, as illustrated in FIG. 2. Preferably, the L-shaped-member 34 may be integrally formed with the substrate 22 and may be formed of the same material as that of the substrate 22. The L-shaped-member 34 may be configured to receive and retain the wiring-harness 14 with the cable-diameter ranging from about 2 mm to about 30 mm.

Step 104, DISPOSE WIRING-HARNESS, may include disposing the wiring-harness 14 within the retention-feature 28 such that the predetermined-point 12 of the wiring-harness 14 is in the predetermined-position 16. The wiring-harness 14 may be disposed within the retention-feature 28 by a hand of a technician, or may be an automated process. Preferably, the retention-feature 28 may locate the predetermined-point 12 of the wiring-harness 14 on the substrate 22 with a true-position of less than 5.0 millimeters (5 mm) relative to the predetermined-position 16. As used herein, the true-position is an allowable tolerance window surrounding the predetermined-position 16 in which the location of the predetermined-point 12 may exist.

The predetermined-point 12 of the wiring-harness 14 may be presented to an assembler in the predetermined-position 16. This is advantageous when the assembler may be a robot (not shown), as the robot may locate and avoid entanglement in the wiring-harness 14 during an installation procedure.

Step 106, REMOVE WIRING-HARNESS, may include removing the wiring-harness 14 from the retention-feature 28 by applying the removal-force 36 using the robot. The removal-force 36 may result from the robot that grasps and moves the electrical-connector 20 retained in a staging-device 40 that may be located on the surface 24, as illustrated in FIG. 1. The robot may remove the electrical-connector 20 from the staging-device 40 thereby moving the attached wiring-harness 14 away from the surface 24 to create the removal-force 36. The robot may mate the electrical-connector 20 with a corresponding-electrical-connector (not shown) as part of the installation procedure. The wiring-harness 14 may disengage from the retention-feature 28 during the installation procedure, depending on a distance and a direction of the movement of the wiring-harness 14 by the robot.

The retention-feature 28 is configured to retain the wiring-harness 14 to the surface 24 until the removal-force 36 applied to the wiring-harness 14 exceeds the predetermined-threshold 38 that may preferably be in a range from about 40 Newtons to about 60 Newtons. The removal-force 36 is preferably applied to the wiring-harness 14 in a direction normal to the surface 24, but may also be applied at angles from zero degrees to 180 degrees, depending on a type and an orientation of the retention-feature 28.

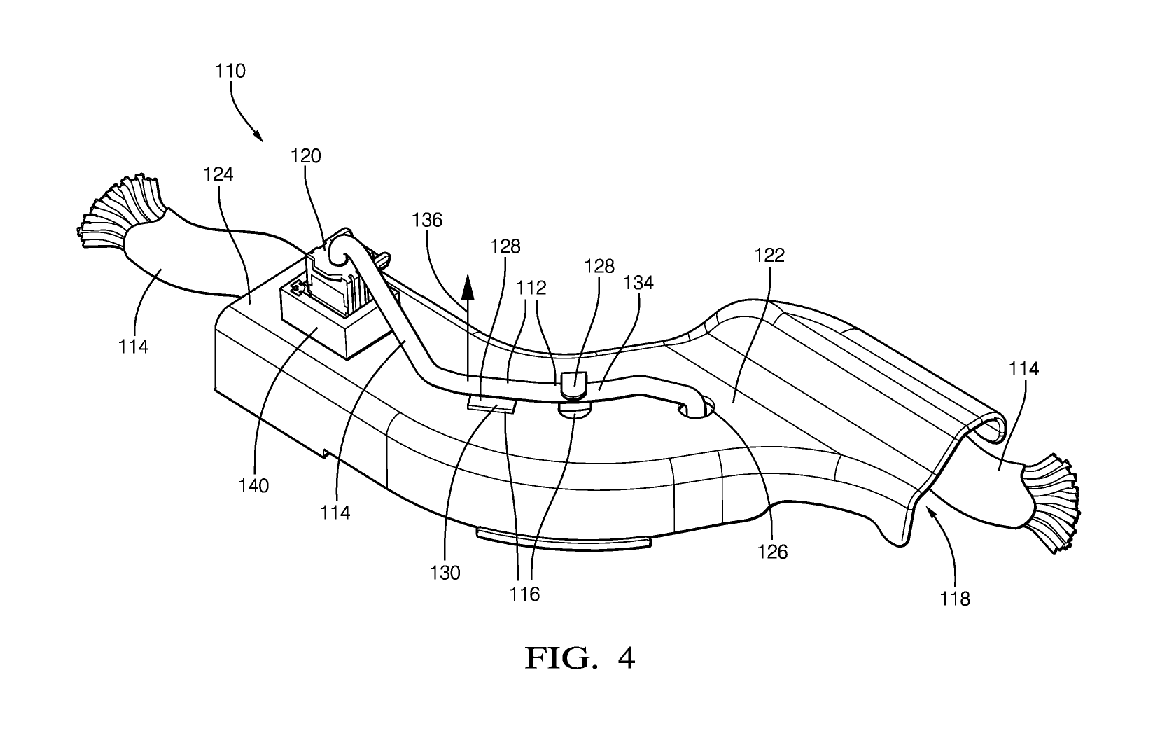

FIG. 4 is an example of yet another embodiment of a retaining-device 110 configured to retain a wiring-harness 114. The retaining-device 110 includes a substrate 122 and a retention-feature 128. The retention-feature 128 is disposed on the substrate 122 and is configured to locate and retain the wiring-harness 114 until a robot (not shown) applies a removal-force 136 to the wiring-harness 114. The retaining-device 110 may be fabricated of a polymeric-material and may house the wiring-harness 114 in an interior chamber 118. The retaining-device 110 may be fixed to an automobile (not shown) during an assembly operation of the vehicle using any of the fasteners (not shown) known to those in the art.

The wiring-harness 114 may include a main-branch (not specifically shown) and wire-bundles (not specifically shown) that may attach to the main-branch within the retaining-device 110 (i.e. within the interior chamber 118). Both the main-branch and the wire-bundles may include electrical-connectors 120 at a terminal-end.

The substrate 122 defines a surface 124, wherein the surface 124 may further define apertures 126 that connect the surface 124 to the interior chamber 118. The wiring-harness 14 may pass through the apertures 126 for attachment to the surface 124, as will be described in more detail below.

Preferably, the retention-feature 28 may locate the predetermined-point 12 of the wiring-harness 14 on the substrate 22 with a true-position of less than 5.0 millimeters (5 mm) relative to the predetermined-position 16. As used herein, the true-position is an allowable tolerance window surrounding the predetermined-position 16 in which the location of the predetermined-point 12 may exist.

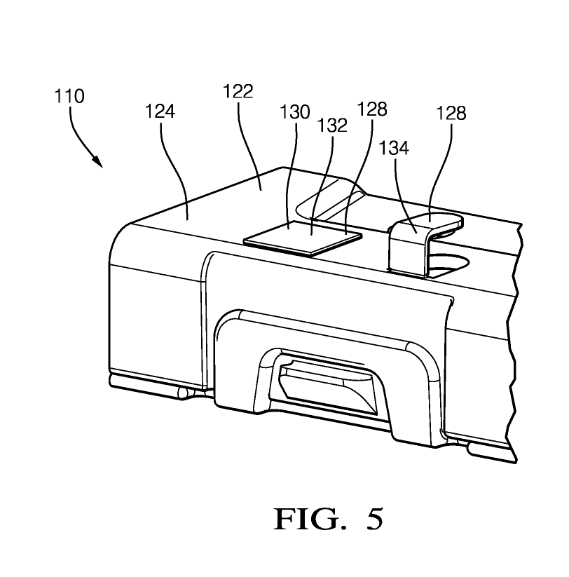

FIG. 5 illustrates a section of the retaining-device 110 with the wiring-harness 114 removed to more clearly show the retention-features 128. The retention-feature 128 may include an exposed adhesive layer 130 that may be formed of a fugitive-glue material 132. The fugitive-glue material 132 may be any fugitive-glue material 132 that is suitable for temporarily joining the substrate 122 material to the wiring-harness 114 material. The fugitive-glue material 132 may be configured to receive and retain the wiring-harness 114 with a cable-diameter (not shown) ranging from about 2 mm to about 30 mm.

The retention-feature 128 may also include a flexible L-shaped-member 134 projecting beyond the surface 124, as illustrated in FIG. 5. Preferably, the L-shaped-member 134 may be integrally formed with the substrate 122 and may be formed of the same material as that of the substrate 122. The L-shaped-member 134 may be configured to receive and retain the wiring-harness 114 with the cable-diameter ranging from about 2 mm to about 30 mm.

The retention-feature 128 is configured to retain the wiring-harness 114 to the surface 124 until a removal-force 136 applied to the wiring-harness 114 exceeds a predetermined-threshold 138 that may preferably be in a range from about 40 Newtons to about 60 Newtons. The removal-force 136 is preferably applied to the wiring-harness 114 in a direction normal to the surface 124, but may also be applied at angles from zero degrees to 180 degrees, depending on a type and an orientation of the retention-feature 128.

The predetermined-point 112 of the wiring-harness 114 may be presented to an assembler in the predetermined-position 116. This is advantageous when the assembler is the robot, as the robot may locate and avoid entanglement in the wiring-harness 114 during an installation procedure. The removal-force 136 may result from the robot that grasps and moves the electrical-connector 120 retained in a staging-device 140 that may be located on the surface 124, as illustrated in FIG. 1. The robot may remove the electrical-connector 120 from the staging-device 140 thereby moving the attached wiring-harness 114 away from the surface 124 to create the removal-force 136. The robot may mate the electrical-connector 120 with a corresponding-electrical-connector (not shown) as part of the installation procedure. The wiring-harness 114 may disengage from the retention-feature 128 during the installation procedure, depending on a distance and a direction of the movement of the wiring-harness 114 by the robot.

Accordingly, a wiring-harness retaining device 10 (the device 10), and a method 100 of installing a wiring-harness 14 are provided. The device 10 is beneficial because the device 10 promotes robotic installation of the wiring-harness 14, as the robot may locate and avoid entanglement in the wiring-harness 14 during the installation procedure.

While this invention has been described in terms of the preferred embodiments thereof, it is not intended to be so limited, but rather only to the extent set forth in the claims that follow. Moreover, the use of the terms first, second, upper, lower, etc. does not denote any order of importance, location, or orientation, but rather the terms first, second, etc. are used to distinguish one element from another. Furthermore, the use of the terms a, an, etc. do not denote a limitation of quantity, but rather denote the presence of at least one of the referenced items.

We claim:

1. A wiring-harness retaining device configured to retain a predetermined-point of a wiring-harness in a predetermined-position, said device comprising:
a substrate defining a surface; and
a retention-feature disposed on said surface configured to retain the wiring-harness to the surface until a removal-force applied to the wiring-harness exceeds a predetermined-threshold, wherein the predetermined-point of the wiring-harness is presented to an assembler in the predetermined-position.

2. The device in accordance with claim 1, wherein the retention-feature includes an exposed adhesive layer.

3. The device in accordance with claim 2, wherein the exposed adhesive layer is formed of a fugitive-glue material.

4. The device in accordance with claim 1, wherein the retention-feature includes a flexible L-shaped-member projecting beyond the surface.

5. The device in accordance with claim 4, wherein the L-shaped-member is integrally formed with the substrate and wherein the substrate and the L-shaped-member are formed of the same material.

6. The device in accordance with claim 1, wherein the predetermined-threshold is in a range from about 40 Newtons to about 60 Newtons.

7. The device in accordance with claim 1, wherein the retention-feature locates the predetermined-point on the substrate with a true-position of less than 5.0 millimeters relative to the predetermined-position.

8. The device in accordance with claim 1, wherein the assembler is a robot.

9. A method of installing a wiring-harness in a motor vehicle, comprising the steps of:
providing a substrate defining a surface having a retention-feature disposed on said surface configured to retain the wiring-harness to the surface until a removal-force applied to the wiring-harness exceeds a predetermined-threshold;
disposing the wiring-harness within the retention-feature such that a predetermined-point of the wiring-harness is in a predetermined-position;
removing the wiring-harness from the retention-feature by applying the removal-force using a robot.

10. The method in accordance with claim 9, wherein the retention-feature includes an exposed adhesive layer.

11. The method in accordance with claim 10, wherein the exposed adhesive layer is formed of a fugitive-glue material.

12. The method in accordance with claim 9, wherein the retention-feature includes a flexible L-shaped member projecting beyond the surface.

13. The method in accordance with claim 12, wherein the L-shaped-member is integrally formed with the substrate and wherein the substrate and the L-shaped-member are formed of the same material.

14. The method in accordance with claim 9, wherein the predetermined-threshold is in a range from about 40 Newtons to about 60 Newtons.

15. The method in accordance with claim 9, wherein the retention-feature locates the predetermined-point on the substrate with a true-position of less than 5.0 millimeters relative to the predetermined-position.

16. A retaining-device configured to retain a wiring-harness, comprising:
a substrate; and
a retention-feature disposed on the substrate configured to locate and retain the wiring-harness until a robot applies a removal-force to the wiring-harness.
